(19) United States
(12) Patent Application Publication
(10) Pub. No.: US 2021/0231978 A1
(43) Pub. Date: Jul. 29, 2021

(54) Liquid Crystal Lens and Liquid Crystal Glasses

(71) Applicant: BOE Technology Group Co., Ltd., Beijing (CN)

(72) Inventor: Haiyan Wang, Beijing (CN)

(73) Assignee: BOE Technology Group Co., Ltd., Beijing (CN)

(21) Appl. No.: 16/964,499

(22) PCT Filed: Feb. 26, 2020
(86) PCT No.: PCT/CN2020/076768

§ 371 Date: Jul. 23, 2020

(30) Foreign Application Priority Data
Apr. 19, 2019 (CN) 201910320240.2

(51) Int. Cl. G02C 7/08; G02F 1/29

(52) U.S. Cl. CPC G02C 7/083; G02C 2202/20; G02F 1/294

(57) ABSTRACT

A liquid crystal lens is provided and includes a first substrate, a second substrate opposite to the first substrate, and a liquid crystal layer between the first substrate and the second substrate, a first electrode on a side of the first substrate that faces the second substrate, and a second electrode on a side of the second substrate that faces the first substrate, and a Fresnel lens between the first substrate and the liquid crystal layer. The Fresnel lens including a flat first surface and a second surface provided with a teeth profile that are arranged opposite to each other, and the liquid crystal layer being on a side of the second surface that is away from the first surface. The first electrode is on a side of the Fresnel lens that faces the first substrate, and the first electrode includes a plurality of sub-electrodes separated from each other.

The present application claims priority of Chinese Patent Application No. 201910320240.2 filed on Apr. 19, 2019, the disclosure of which is incorporated herein by reference in its entirety as part of the present application.

### TECHNICAL FIELD

At least one embodiment of the present disclosure relates to a liquid crystal lens and liquid crystal glasses.

### BACKGROUND

A liquid crystal has a relatively great photoelectric anisotropy, and now is widely applied to various optical devices, such as liquid crystal displays, liquid crystal lenses, and liquid crystal phase retarders. Liquid crystal glasses are another research hotspot after the liquid crystal display, and comprise single round hole electrode liquid crystal glasses, model electrode liquid crystal glasses, and embossed shape liquid crystal glasses.

### SUMMARY

At least one embodiment of the disclosure provides a liquid crystal lens and liquid crystal glasses.

At least one embodiment of the disclosure provides a liquid crystal lens comprising: a first substrate, a second substrate opposite to the first substrate, and a liquid crystal layer between the first substrate and the second substrate; a first electrode on a side of the first substrate that faces the second substrate, and a second electrode located on a side of the second substrate that faces the first substrate; and a Fresnel lens between the first substrate and the liquid crystal layer, the Fresnel lens including a flat first surface and a second surface provided with a teeth profile that are arranged opposite to each other, and the liquid crystal layer being on a side of the second surface that is away from the first surface, wherein the first electrode is on a side of the Fresnel lens that faces the first substrate, and the first electrode includes a plurality of sub-electrodes separated from each other.

For example, the Fresnel lens includes a central portion and a plurality of ring portions surrounding the central portion; an orthogonal projection of the central portion on the first substrate is a circle; in a direction from a center toward a circumference of the circle, a thicknesses of the central portion and a thickness of each of the plurality of ring portions gradually change, and both have a same trend of change in thickness, the plurality of sub-electrodes include a central electrode and a ring electrode surrounding the central electrode; and the center of the circle is located within an orthogonal projection of the central electrode on the first substrate.

For example, the plurality of sub-electrodes are arranged in different layers; an insulating layer is provided between two adjacent layers of sub-electrodes; in the direction from the center toward the circumference of the circle, the thickness of the central portion and the thickness of each of the plurality of ring portions both gradually decrease; distances from a first part of sub-electrodes corresponding to the central portion in the plurality of sub-electrodes to the first substrate gradually decrease; and distances from a second part of sub-electrodes corresponding to each of the ring portions in the plurality of sub-electrodes to the first substrate gradually decrease.

For example, the plurality of sub-electrodes are arranged in different layers; an insulating layer is provided between two adjacent layers of sub-electrodes; in the direction from the center toward the circumference of the circle, the thickness of the central portion and the thickness of each of the plurality of ring portions both gradually increase; distances from a first part of sub-electrodes corresponding to the central portion in the plurality of sub-electrodes to the first substrate gradually increase; and distances from a second part of sub-electrodes corresponding to each of the ring portions in the plurality of sub-electrodes to the first substrate gradually increase.

For example, a dielectric constant of the insulating layer is substantially the same as a dielectric constant of the Fresnel lens.

For example, a number of layers of the first part of sub-electrodes and a number of layers of the second part of sub-electrodes are both N; and in a direction perpendicular to the first substrate, a distance from an m-th layer of the first part of sub-electrodes to the first substrate is equal to a distance from an m-th layer of the second part of sub-electrodes to the first substrate, where N≥3 and N≥m≥1.

For example, the plurality of sub-electrodes include a plurality of first sub-electrode groups located in a same layer; each of the plurality of ring portions and the central portion are in one-to-one correspondence with the plurality of first sub-electrode groups; and each of the plurality of first sub-electrode groups includes at least two sub-electrodes insulated from each other; in the direction from the center toward the circumference of the circle, the thickness of the central portion and the thickness of each of the plurality of ring portions both gradually decrease; and the at least two sub-electrodes are configured to be applied with voltages that gradually decrease; or in the direction from the center toward the circumference of the circle, the thickness of the central portion and the thickness of each of the plurality of ring portions both gradually increase; and the at least two sub-electrodes are configured to be applied with voltages that gradually increase.

For example, each of the plurality of first sub-electrode groups includes two sub-electrodes; a side of each of the plurality of first sub-electrode groups that faces the Fresnel lens is provided with a high-resistance film; and the high-resistance film is disconnected at a gap between two adjacent first sub-electrode groups in the plurality of first sub-electrode groups.

For example, in the direction from the center toward the circumference of the circle, a size of a portion where each sub-electrode overlaps with the high-resistance film is ½ to ⅕ of a size of the sub-electrode.

For example, in the direction from the center toward the circumference of the circle, a size of each of the sub-electrodes is 4.0 μm to 6.5 μm.

For example, the plurality of sub-electrodes include a first electrode group corresponding to the central portion and a second electrode group corresponding to each of the plurality of ring portions; the first electrode group and the second electrode group each include at least two second sub-electrode groups; and each of the at least two second sub-electrode groups includes at least two third sub-electrodes located in different layers; in the direction from the center toward the circumference of the circle, the thickness of the central portion and the thickness of each of the plurality of ring portions both gradually decrease; in each of the second sub-electrode groups, distances from the at least two third sub-electrodes to the first substrate gradually decrease; and the at least two third sub-electrodes are configured to be applied with a same voltage; or in the direction from the center toward the circumference of the circle, the thickness of the central portion and the thickness of each of the plurality of ring portions both gradually increase; in each of the second sub-electrode groups, distances from the at least two third sub-electrodes to the first substrate gradually increase; and the at least two third sub-electrodes are configured to be applied with a same voltage.

For example, numbers of layers of third sub-electrodes in the first electrode group and the second electrode group are both P; and in a direction perpendicular to the first substrate, a distance from a q-th layer of third sub-electrodes in the second electrode group to the first substrate is equal to a distance from a q-th layer of third sub-electrodes in the first electrode group to the first substrate, where P≥2 and P≥q≥1; in the direction from the center toward the circumference of the circle, the thickness of the central portion and the thickness of each of the plurality of ring portions both gradually decrease; the at least two second sub-electrode groups corresponding to the central portion are configured to be applied with voltages that gradually decrease; and the at least two second sub-electrode groups corresponding to each of the plurality of ring portions are configured to be applied with voltages that gradually decrease; or in the direction from the center toward the circumference of the circle, the thickness of the central portion and the thickness of each of the plurality of ring portions both gradually increase; the at least two second sub-electrode groups corresponding to the central portion are configured to be applied with voltages that gradually increase; and the at least two second sub-electrode groups corresponding to each of the plurality of ring portions are configured to be applied with voltages that gradually increase.

For example, the first electrode group and the second electrode group include the same number of second sub-electrode groups; the at least two second sub-electrode groups corresponding to the central portion are electrically connected with the at least two second sub-electrode groups corresponding to the plurality of ring portions in one-to-one correspondence; and the at least two second sub-electrode groups corresponding to two adjacent ring portions in the plurality of ring portions are electrically connected in one-to-one correspondence.

For example, a refractive index of a liquid crystal in the liquid crystal layer is configured to change between a first refractive index n1 and a second refractive index n2; and a refractive index n0 of the Fresnel lens satisfies: n1≥n0≥n2.

At least one embodiment of the disclosure provides a liquid crystal lens comprising: a first substrate, a second substrate opposite to the first substrate, and a liquid crystal layer located between the first substrate and the second substrate; a first electrode on a side of the first substrate that faces the second substrate, and a second electrode on a side of the second substrate that faces the first substrate; and a Fresnel lens between the first substrate and the liquid crystal layer; the Fresnel lens including a flat first surface and a second surface provided with a teeth profile that are arranged opposite to each other; and the liquid crystal layer being on a side of the second surface that is away from the first surface, wherein the first electrode is a continuous electrode located on the second surface of the Fresnel lens.

For example, the first electrode is conformally formed on the second surface of the Fresnel lens.

For example, a thickness of the first electrode in a direction perpendicular to the first substrate is 0.04 μm to 0.07 μm.

At least one embodiment of the disclosure provides a liquid crystal glasses, comprising the liquid crystal lens according to any one mentioned above.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1A is a partial cross-sectional structural schematic diagram of liquid crystal glasses;

FIG. 1B is a schematic plan view taken along line AA of the liquid crystal glasses shown in FIG. 1A;

FIG. 1C is an enlarged schematic diagram of deflection states of liquid crystals within a region 1 located above a central portion of a Fresnel lens when an intermediate state voltage is applied to a first transparent electrode;

FIG. 2A is a partial cross-sectional schematic diagram of a liquid crystal lens provided by an example of an embodiment of the present disclosure;

FIG. 2B is a schematic plan view taken along line BB of the liquid crystal lens shown in FIG. 2A;

FIG. 2C is another schematic diagram showing arrangement of a first electrode in a region C shown in FIG. 2A;

FIG. 2D is another schematic diagram showing arrangement of the first electrode in the region C shown in FIG. 2A;

FIG. 2E is a partial cross-sectional schematic diagram of the liquid crystal lens provided by another example of the embodiment of the present disclosure;

FIG. 3A is a partial cross-sectional schematic diagram of the liquid crystal lens provided by another example of the embodiment of the present disclosure;

FIG. 3B is a partial cross-sectional schematic diagram of the liquid crystal lens provided by another example of the embodiment of the present disclosure;

FIG. 4A is a partial cross-sectional schematic diagram of the liquid crystal lens provided by another example of the embodiment of the present disclosure;

FIG. 4B is an enlarged schematic diagram of a region D in FIG. 4A;

FIG. 5 is a partial cross-sectional schematic diagram of a liquid crystal lens provided by another embodiment of the present disclosure; and

FIG. 6 is a schematic diagram of deflection states of liquid crystals in a region located above the central portion of the Fresnel lens when the intermediate state voltage is applied to the first electrode according to the embodiments shown in FIG. 2A to FIG. 2D and FIG. 3A to FIG. 5.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise specified, the technical terms or scientific terms used in the disclosure shall have normal meanings understood by those skilled in the art. The words “first”, “second” and the like used in the disclosure do not indicate the sequence, the number or the importance but are only used for distinguishing different components. The word “comprise”, “include” or the like only indicates that an element or a component before the word contains elements or components listed after the word and equivalents thereof, not excluding other elements or components.

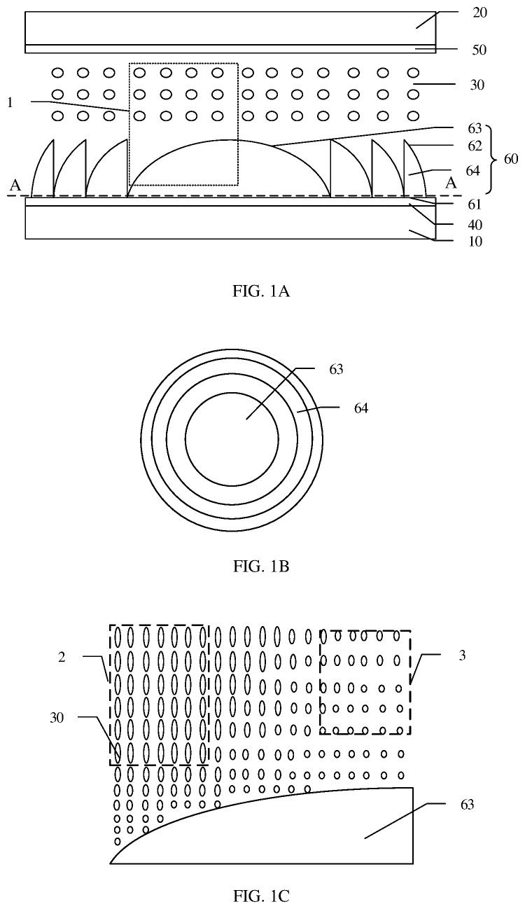

FIG. 1A is a partial cross-sectional structural schematic diagram of liquid crystal glasses; and FIG. 1B is a schematic plan view taken along line AA of the liquid crystal glasses shown in FIG. 1A. As shown in FIG. 1A, the liquid crystal glasses comprise a first transparent substrate 10 and a second transparent substrate 20 which are provided opposite to each other, as well as a liquid crystal layer 30 located between the first transparent substrate 10 and the second transparent substrate 20. A side of the first transparent substrate 10 that faces the second transparent substrate 20 is provided with a whole-surface first transparent electrode 40; a side of the second transparent substrate 20 that faces the first transparent substrate 10 is provided with a whole-surface second transparent electrode 50; and a side of the first transparent electrode 40 that faces the liquid crystal layer 30 is provided with a Fresnel lens 60.

As shown in FIG. 1A and FIG. 1B, a first surface 61 on a side of the Fresnel lens 60 that faces the first transparent electrode 40 may be a flat surface; and a second surface 62 on a side of the Fresnel lens 60 that faces the liquid crystal layer 30 is provided with a teeth profile, that is, the side of the Fresnel lens 60 that faces the liquid crystal layer 30 is provided with protrusions distributed at intervals according to Fresnel zones. The Fresnel zones are constituted by a circle in a center and a plurality of rings arranged concentrically with the circle, the circle and each ring each being one zone of the Fresnel zones. The Fresnel lens 60 includes a central portion 63 corresponding to the circle in the center of the Fresnel zones and a ring portion 64 corresponding to the rings of the Fresnel zones.

The liquid crystal in the liquid crystal layer 30 has a birefringence; the liquid crystal has a refractive index as an abnormal light refractive index in a power-off state, and a refractive index as a normal light refractive index in a power-on state. For example, the liquid crystal is an optically positive liquid crystal, and the abnormal light refractive index thereof is greater than the normal light refractive index, for example, the normal light refractive index is about 1.5, and the abnormal light refractive index is about 1.6 to 1.8. For the Fresnel lens 60, for example, a material having a refractive index substantially equal to the abnormal light refractive index of the liquid crystal may be selected.

For example, the liquid crystal may be a rod-shaped liquid crystal; the liquid crystal remains horizontal in a power-off state, that is, a long axis of the liquid crystal is parallel to the first transparent substrate 10 (as shown in FIG. 1A); and the liquid crystal remains vertical in a power-on state, that is, the long axis of the liquid crystal is perpendicular to the first transparent substrate 10.

For example, when voltages of the first transparent electrode 40 and the second transparent electrode 50 are both 0 V, the liquid crystals are in a power-off state, and the refractive index thereof is substantially equal to the refractive index of the Fresnel lens 60, so the liquid crystal layer 30 and Fresnel lens 60 are equivalent to a flat dielectric layer, and parallel light (e.g., linearly polarized light) incident on the liquid crystal glasses from the first transparent substrate 10 does not change a propagation direction, that is, light emergent from the second transparent substrate 20 is still parallel light.

For example, when a high voltage is applied to the first transparent electrode 40, the liquid crystals are subjected to a strong electric field, deflection of the liquid crystals is even, and the refractive index of the liquid crystal layer 30 is less than the refractive index of the Fresnel lens 60. The parallel light incident on the liquid crystal glasses from the first transparent substrate 10 is converged at an interface between the Fresnel lens 60 and the liquid crystal layer 30, and at this time, the liquid crystal glasses functions as a convergent lens. Therefore, the liquid crystal glasses may be switched between light convergence and transmission functions.

As compared with a structure in which liquid crystal deflection is controlled by the electric field to implement controlling an arrangement shape of the liquid crystals to be equivalent to the Fresnel lens, the structure shown in FIG. 1A may avoid a problem of big crosstalk due to a great difficulty in precise control during a process in which liquid crystal deflection is controlled by an electrode to form a Fresnel cycle.

In the study, an inventor of the present application finds that: when an intermediate state voltage (e.g., a 3.5 V voltage) is applied to the first transparent electrode, a thickness difference between different positions of the Fresnel lens will cause uneven distribution of the electric field acting on the liquid crystals. Under an action of the applied electric field generated by the intermediate state voltage, the thicker the position of the Fresnel lens, the greater the weakening influence of an induced electric field generated in the position on the applied electric field, so, the thicker the position of the Fresnel lens, the weaker the electric field strength corresponding to the position that acts on the liquid crystals, which results in uneven deflection of the liquid crystals above Fresnel lens having different thicknesses. FIG. 1C is an enlarged schematic diagram of deflection states of liquid crystals within a region 1 located above the central portion of the Fresnel lens when the intermediate state voltage is applied to the first transparent electrode. As shown in FIG. 1C, taking liquid crystals located at the central portion of the Fresnel lens as an example, the liquid crystals in a region 2 above a thinner position (a low arch region) at the central portion are substantially in a normally deflected state (vertical to the first transparent substrate), a part of liquid crystals in a region 3 above a thicker position (a high arch region) at the central portion are still in an undeflected state (parallel to the first transparent substrate). At this time, refractive indices of respective positions of the liquid crystal layer are uneven, and stray light will appear, resulting in blurred imaging. Therefore, the liquid crystals in the liquid crystal glasses shown in FIG. 1A may only be at two different refractive indices, which cannot implement continuous change in refractive index, and cannot implement adjustable degrees of the glasses.

Embodiments of the present disclosure provide a liquid crystal lens and liquid crystal glasses. The liquid crystal lens comprises: a first substrate, a second substrate provided opposite to the first substrate, a liquid crystal layer located between the first substrate and the second substrate, a first electrode located on a side of the first substrate that faces the second substrate, a second electrode located on a side of the second substrate that faces the first substrate, and a Fresnel lens located between the first substrate and the liquid crystal layer. The Fresnel lens includes a flat first surface and a second surface provided with a teeth profile that are arranged opposite to each other; and the liquid crystal layer is located on a side of the second surface that is away from the first surface. The first electrode is located on a side of the Fresnel lens that faces the first substrate; and the first electrode includes a plurality of sub-electrodes separated from each other. In the embodiments of the present disclosure, the plurality of sub-electrodes may have a voltage thereof controlled to implement uniform and continuous change in a refractive index of a liquid crystal, thereby further implementing continuous adjustment of degrees of the liquid crystal lens.

Hereinafter, the liquid crystal lens and the liquid crystal glasses provided by the embodiments of the present disclosure will be described in conjunction with the accompanying drawings.

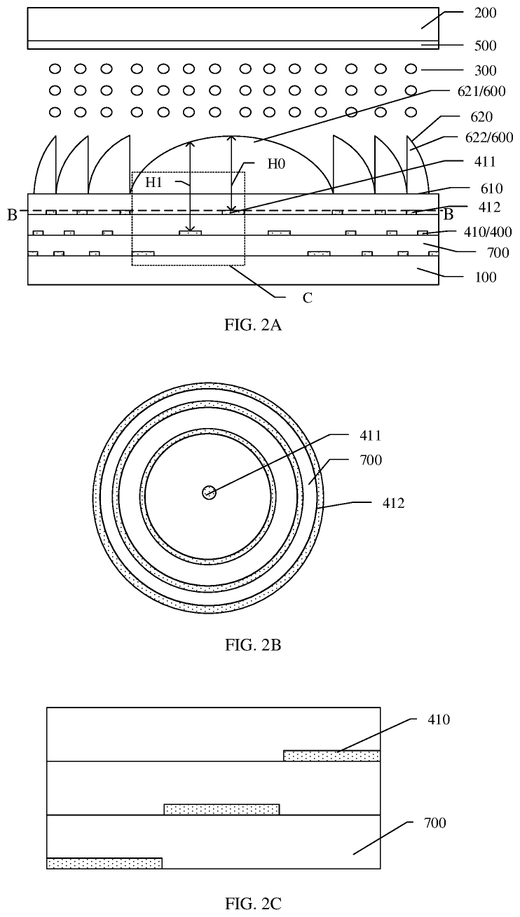

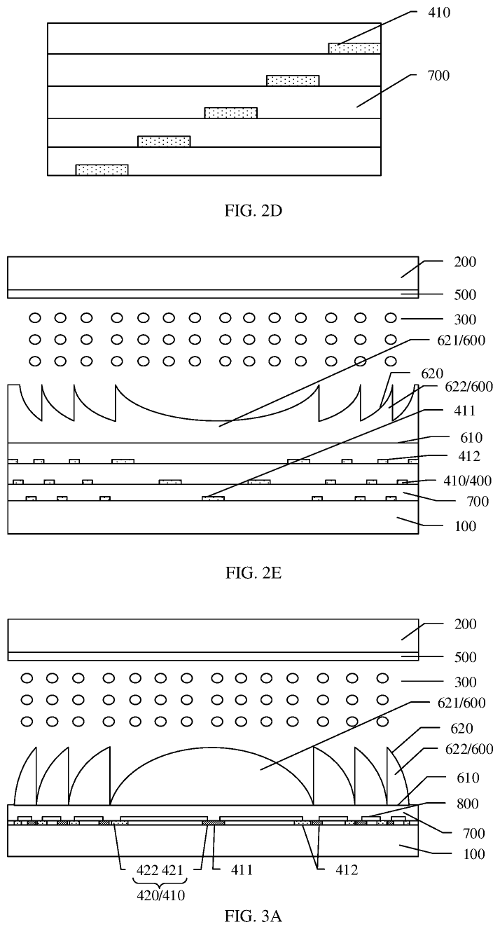

FIG. 2A is a partial cross-sectional schematic diagram of a liquid crystal lens provided by an example of an embodiment of the present disclosure; and FIG. 2B is a schematic plan view taken along line BB of the liquid crystal lens shown in FIG. 2A. As shown in FIG. 2A, the liquid crystal lens comprises: a first substrate 100, a second substrate 200 provided parallel and opposite to the first substrate 100, a liquid crystal layer 300 located between the first substrate 100 and the second substrate 200, a first electrode 400 located on a side of the first substrate 100 that faces the second substrate 200, and a second electrode 500 located on a side of the second substrate 200 that faces the first substrate 100.

Both the first substrate 100 and the second substrate 200 according to the embodiment of the present disclosure are transparent substrates, to implement light transmission. For example, the first substrate 100 and the second substrate 200 may be glass substrates, or may be made of transparent materials such as polydimethylsiloxane (PDMS) or polymethyl methacrylate (PMMA), to prevent the first substrate 100 and the second substrate 200 from affecting light transmittance.

Both the first electrode 400 and the second electrode 500 according to the embodiment of the present disclosure are transparent electrodes to implement light transmission. For example, the first electrode 400 and the second electrode 500 may be made of transparent conductive metal oxides or transparent conductive organic polymer materials. For example, the first electrode 400 and the second electrode 500 may be made of indium tin oxide or indium zinc oxide, etc. to ensure transparency of the two electrodes. For example, a thickness of the first electrode 400 in a direction perpendicular to the first substrate 100 may be 0.04 μm to 0.07 μm.

As shown in FIG. 2A, the liquid crystal lens further comprises a Fresnel lens 600 located on a side of the first substrate 100 that faces the liquid crystal layer 300; the Fresnel lens 600 includes a flat first surface 610 and a second surface provided with a teeth profile that are arranged opposite to each other; the liquid crystal layer 300 is located on a side of the second surface 620 of the Fresnel lens 600 that is away from the first surface 610; and the teeth profile provided on the second surface 620 of the Fresnel lens 600 is a structure distributed at intervals according to Fresnel zones. The Fresnel lens 600 includes a central portion 621 corresponding to a central circle of the Fresnel zones and a plurality of ring portions 622 surrounding the central portion 621; the ring portion 622 corresponds to a ring shape of the Fresnel zones; and the central portion 621 and the ring portion 622 have a concentric structure.

For example, as shown in FIG. 2A, an orthogonal projection of the central portion 621 on the first substrate 100 is a circle; in a direction from a center toward a circumference of the circle, a thickness of the central portion 621 gradually changes, a thickness of each ring portion 622 gradually changes, and the central portion 621 and each ring portion 622 have a same trend of change in thickness. For example, in the example shown in FIG. 2A, in the direction from the center toward the circumference of the circle, the thickness of the Fresnel lens 600 in a position where the central portion 621 is located gradually decreases, that is, a portion in the central portion 621 that is closer to the ring portion 622 has a smaller thickness, and the second surface 620 of the central portion 621 of the Fresnel lens 600 is a spherical surface. In a direction from a side closer to the central portion 621 toward a side away from the central portion 621, a thickness of the Fresnel lens 600 in a position where each ring portion 622 is located gradually decreases.

For example, in the direction from the center toward the circumference of the circle, a size of the ring portion 622 is not less than 25 μm. For example, a radius of the circle in the Fresnel zones satisfies rᵢ(ifλ)^{1/2}, where i is a sequence number of a circle in the Fresnel zones (in a direction from a center toward a circumference of the Fresnel zones, the sequence number gradually increases), f is a focal length of the Fresnel lens, and λ is a wavelength of incident light, then, a size of an (i-1)-th (a second circle corresponds to a first ring portion) ring portion 622 is d=rᵢ−rᵢ₋₁.

As shown in FIG. 2A, the first electrode 400 is located on a side of the first surface 610 of the Fresnel lens 600 that faces the first substrate 100; and the first electrode 400 includes a plurality of sub-electrodes 410 separated from each other. In the embodiment of the present disclosure, the first electrode is set to a structure including a plurality of sub-electrodes separated from each other, and a problem of uneven electric field distribution caused by thicknesses of the Fresnel lens may be made up as far as possible by respectively controlling voltages of the plurality of sub-electrodes, so that deflection of the liquid crystals is substantially uniform, to further achieve a purpose of continuous change in the liquid crystal refractive index and continuously adjustable degrees of the liquid crystal lens.

For example, a side of the second electrode 500 that faces the liquid crystal layer 300 and a side of the Fresnel lens 600 that faces the liquid crystal layer 300 each are provided with an alignment film with a same alignment direction, so that the liquid crystal has an optical axis parallel to the first substrate 100 when it is not subjected to an electric field.

For example, a side of the first electrode 400 that is away from the Fresnel lens 600 may further include a polarizing layer (not shown); and polarized light emergent after incident light passes through the polarizing layer may be modulated by the Fresnel lens 600 and the liquid crystal layer 300, and then emergent from the second substrate 200. The above-described polarizing layer may be provided between the first electrode and the first substrate, or may be provided on a side of the first substrate that is away from the first electrode, which will not be limited in the embodiment of the present disclosure. The embodiment of the present disclosure is not limited to providing the polarizing layer on the liquid crystal lens, and a matching liquid crystal lens with a structure completely the same as the liquid crystal lens may also be stacked on a side of the second substrate 200 of the liquid crystal lens shown in FIG. 2A that is away from the first substrate 100; and the matching liquid crystal lens differs from the liquid crystal lens shown in FIG. 2A in that alignment directions of alignment films of the two are perpendicular to each other, to respectively modulate two polarized light components perpendicular to each other in natural light.

For example, the liquid crystal in the liquid crystal layer 300 is an anisotropic crystal. Taking the liquid crystal as an optic uniaxial crystal, when a beam of polarized light passes through one optic uniaxial crystal, two beams of polarized light are formed, and the phenomenon is referred to as birefringence. Light of an optic uniaxial liquid crystal has refractive indices of n_{y} and n_{z} when propagating in an x direction, has refractive indices of nₓ and n_{z} when propagating in a y direction, and has only one refractive index nₓ(=n_{y}) when propagating in a z direction, so a z-axis of the optic uniaxial liquid crystal is referred to as an optical axis. If a propagation direction of the light is not on the xyz axes, light whose vibration direction is perpendicular to the optical axis is generally referred to as normal light, and light whose vibration direction is parallel to the optical axis is referred to as abnormal light. A refractive index of normal light is defined as n_{⊥}, a refractive index of abnormal light is defined as n_{∥}, and a birefringence is defined as Δn=n_{∥}−n₁₉₅ . In the embodiment of the present disclosure, the refractive index of the liquid crystal in the liquid crystal layer 300 is configured to change between a first refractive index n1 and a second refractive index n2; one of the first refractive index n1 and the second refractive index n2 is a normal light refractive index, and the other is an abnormal light refractive index, which will be described by taking n1>n2 as an example. When the liquid crystal is an optically positive liquid crystal, n_{∥}>n₁₉₅ , Δn>0, the embodiment of the present disclosure will be described by taking the liquid crystal as an optically positive liquid crystal, a refractive index of the liquid crystal in a power-off state (the state shown in FIG. 2A) is the abnormal light refractive index, and a refractive index in a power-on state is the normal light refractive index.

For example, a refractive index n0 of the Fresnel lens 600 satisfies: n1≥n0≥n2.

For example, when a voltage applied to the first electrode 400 and the second electrode 500 is 0 V, the long axis of the liquid crystal is parallel to the first substrate 100 (the state shown in FIG. 2A), at which time, a vibration direction of incident polarized light is parallel to the optical axis of the liquid crystal, and the refractive index of the liquid crystal is n1; when a high voltage is applied to the first electrode 400 and a 0 V voltage is applied to the second electrode 500, the liquid crystal is subjected to a strong electric field, and the long axis thereof is perpendicular to the first substrate 100, at which time, the vibration direction of the incident polarized light is perpendicular to the optical axis of the liquid crystal, and the refractive index of the liquid crystal is n2.

For example, by taking the refractive index of the Fresnel lens 600 n0=n1 as an example, the refractive index of the Fresnel lens 600 is equal to the refractive index of the liquid crystal layer 300 in a power-off state, at which time, the Fresnel lens 600 and the liquid crystal layer 300 may act as a flat plate structure and has no influence on a propagation direction of incident parallel light. When the liquid crystal is in a power-on state, since the refractive index of the Fresnel lens 600 is greater than the refractive index of the liquid crystal layer 300 in the power-on state, the parallel light incident at an interface between the Fresnel lens 600 and the liquid crystal layer 300 is converged, and a combination of the Fresnel lens 600 and the liquid crystal layer 300 functions as a convergent lens. Thus, the liquid crystal lens may be switched between light convergence and transmission functions.

For example, by taking the refractive index of the Fresnel lens 600 n0=n2 as an example, the refractive index of the Fresnel lens 600 is equal to the refractive index of the liquid crystal layer 300 in a power-on state, at which time, the Fresnel lens 600 and the liquid crystal layer 300 may act as a flat plate structure, and has no influence on a propagation direction of incident parallel light. When the liquid crystal is in a power-off state, since the refractive index of the Fresnel lens 600 is less than the refractive index of the liquid crystal layer 300 in the power-off state, the parallel light incident at the interface between the Fresnel lens 600 and the liquid crystal layer 300 is diverged, and the combination of the Fresnel lens 600 and the liquid crystal layer 300 functions as a divergent lens. Thus, the liquid crystal lens may be switched between light divergence and transmission functions.

For example, by taking that the refractive index n0 of the Fresnel lens 600 satisfies n1>n0>n2 as an example, the refractive index of the Fresnel lens 600 is greater than the refractive index of the liquid crystal layer 300 in a power-on state, at which time, parallel light incident at the interface between the Fresnel lens 600 and the liquid crystal layer 300 is converged, and the combination of the Fresnel lens 600 and the liquid crystal layer 300 functions as a convergent lens. When the liquid crystal is in a power-off state, since the refractive index of the Fresnel lens 600 is less than the refractive index of the liquid crystal layer 300 in the power-off state, the parallel light incident at the interface between the Fresnel lens 600 and the liquid crystal layer 300 is diverged, and the combination of the Fresnel lens 600 and the liquid crystal layer 300 functions as a divergent lens. Thus, the liquid crystal lens may be switched between light divergence and convergence functions.

In the embodiment of the present disclosure, the liquid crystal lens may be switched between a plurality of functions by matching the refractive index of the Fresnel lens with the refractive index of the liquid crystal layer.

For example, as shown in FIG. 2A and FIG. 2B, the plurality of sub-electrodes 410 include a central electrode 411 and a ring electrode 412 surrounding the central electrode 411; and the central electrode 411 corresponds to the center of the circle, that is, the center of the circle is located within an orthogonal projection of the central electrode 411 on the first substrate 100.

For example, as shown in FIG. 2A and FIG. 2B, the central electrode 411 may be a circle; the ring electrode 412 may be a circular ring; and the central electrode 411 and the ring electrode 412 may have a concentric structure.

For example, as shown in FIG. 2A and FIG. 2B, the plurality of sub-electrodes 410 are arranged in different layers; and an insulating layer 700 is provided between two adjacent layers of sub-electrodes 410. The embodiment of the present disclosure takes that the plurality of sub-electrodes corresponding to the central portion or each ring portion are all located in different layers as an example.

For example, as shown in FIG. 2A and FIG. 2B, in the direction from the center toward the circumference of the circle, distances from a part of sub-electrodes 410 corresponding to the central portion 621 in the plurality of sub-electrodes 410 to the first substrate 100 gradually decrease. Orthogonal projections of the part of sub-electrodes 410 corresponding to the central portion 621 in the plurality of sub-electrodes 410 on the first substrate 100 are located within the orthogonal projection of the central portion 621 on the first substrate 100; the part of sub-electrodes 410 include one central electrode 411 and at least two ring electrodes 412, and the part of sub-electrodes 410 are all located in different layers. In a direction parallel to the first substrate and from the side closer to the central portion 621 toward the side away from the central portion 621, distances from a part of sub-electrodes 410 corresponding to each ring portion 622 in the plurality of sub-electrodes 410 to the first substrate 100 gradually decrease. Orthogonal projections of the part of the sub-electrodes 410 corresponding to each ring portion 622 in the plurality of sub-electrodes 410 on the first substrate 100 are located within an orthogonal projection of one ring portion 622 on the first substrate 100; and the part of sub-electrodes 410 are all ring electrodes 412, and are respectively located in different layers.

For example, as shown in FIG. 2A, the number of layers of a first part of sub-electrodes 410 corresponding to the central portion 621 and the number of layers of a second part of sub-electrodes 410 corresponding to the ring portion 622 are both N; and in a direction perpendicular to the first substrate 100, a distance from an m-th layer of the first part of sub-electrodes 410 to the first substrate 100 is equal to a distance from an m-th layer of the second part of sub-electrodes 410 to the first substrate 100, where N≥3 and N≥m≥1. FIG. 2A takes N as 3, but it is not limited thereto. For example, the number of layers of sub-electrodes 410 may be 3 to 8. In the embodiment of the present disclosure, the number of layers of the sub-electrodes and widths thereof are determined according to sizes of the central portion and the ring portion that are parallel to the first substrate.

For example, in a case of arrangement of the plurality of sub-electrodes shown in FIG. 2A, the plurality of sub-electrodes 410 may be electrically connected, to reduce the number of leads and reduce a process difficulty. The plurality of sub-electrodes 410 may all be applied with a same voltage, and the voltage may be an intermediate state voltage (e.g., 3.5 V) plus 1.5 V to 3.2 V. Of course, the plurality of sub-electrodes may not be limited to being electrically connected to be applied with a same voltage, or the plurality of sub-electrodes may not be electrically connected, but are respectively applied with a same voltage. The embodiment of the present disclosure is not limited thereto, each layer of sub-electrodes may also be applied with a same voltage, but different layers of sub-electrodes are applied with different voltages; and the distances between the sub-electrodes and the second surface of the Fresnel lens are adjusted, to render uniform deflection of liquid crystals located at respective positions on the Fresnel lens.

As compared with the structure shown in FIG. 1A, when the voltage applied to the sub-electrodes 410 according to the embodiment of the present disclosure is slightly greater than the originally applied intermediate state voltage, influence of the Fresnel lens 600 on the electric field may be compensated as far as possible.

In the example, the distances from the sub-electrodes 410 to the interface between the Fresnel lens 600 and the liquid crystal layer 300 are adjusted, so that after the liquid crystals in respective positions are subjected to an electric field and a molecular force between liquid crystals, deflection degrees of the liquid crystals located on the Fresnel lens 600 of different thicknesses are substantially the same, thereby improving the phenomenon of uneven deflection of the liquid crystals. Therefore, in the embodiment of the present disclosure, different intermediate state voltages may be applied to the sub-electrodes to implement continuous change in the refractive index of the liquid crystal layer, so that the liquid crystal lens acts as a continuous zoom lens with high image quality.

For example, as shown in FIG. 2A, a dielectric constant of the insulating layer 700 is substantially the same as a dielectric constant of the Fresnel lens 600, so that influence of the insulating layer 700 on the electric field is comparable to the influence of the Fresnel lens 600 on the electric field. FIG. 2A schematically shows that an insulating layer 700 is provided between sub-electrodes 410 closest to the Fresnel lens 600 and the Fresnel lens 600. However, it is not limited thereto, there may also be no insulating layer between the sub-electrodes closest to the Fresnel lens and the Fresnel lens, at which time, a planarization layer for planarizing is provided between two adjacent ones in a layer of sub-electrodes closest to the Fresnel lens.

For example, a refractive index of the insulating layer 700 may be substantially the same as the refractive index of the Fresnel lens 600.

For example, by taking the central electrode 411 corresponding to the central portion 621 and the ring electrode 412 adjacent to the central electrode 411 as an example, according to comprehensive factors such as a distance from the ring electrode 412 to the second electrode 500, a distance from the central electrode 411 to the second electrode 500, and a molecular force between liquid crystals, a distance H1 from the ring electrode 412 to the interface between the Fresnel lens 600 and the liquid crystal layer 300 (the second surface 620 of the Fresnel lens 600) and a distance H0 from the central electrode 411 to the second surface 620 may be obtained through experimental simulations, such that deflection of liquid crystals corresponding to respective positions of the central portion 621 is substantially uniform. In the embodiment of the present disclosure, the distance from the central electrode 411 to the second electrode 500 and the distance from the central electrode 411 to the second surface 620 may be taken as a reference to set a distance from other ring electrode 412 to the second electrode 500 and a distance from the ring electrode 412 to the second surface 620; and a thickness of the insulating layer 700 may be obtained according to the above-described distances.

For example, FIG. 2A schematically shows a case where orthogonal projections of sub-electrodes 410 located in different layers corresponding to the central portion 621 or the ring portion 622 on the first substrate 100 do not overlap with each other, and the number of layers of sub-electrodes 410 is three.

For example, FIG. 2C is another schematic diagram showing arrangement of the first electrode in a region C shown in FIG. 2A. As shown in FIG. 2C, orthogonal projections of the sub-electrodes 410 of respective layers on the first substrate are connected, that is, in the direction perpendicular to the first substrate, one end of a sub-electrode 410 of each layer is aligned with one end of a sub-electrode 410 located on one side thereof, and the other end of the sub-electrode 410 is aligned with one end of a sub-electrode 410 located on the other side thereof.

For example, FIG. 2D is another schematic diagram showing arrangement of the first electrode in the region C shown in FIG. 2A. As shown in FIG. 2D, as compared with the example shown in FIG. 2A, in order that deflection of the liquid crystals is more uniform, more layers of sub-electrodes may be provided in a case where a distance from the first substrate to the first surface of the Fresnel lens is fixed.

FIG. 2E is a partial cross-sectional schematic diagram of the liquid crystal lens provided by another example of the embodiment of the present disclosure. As shown in FIG. 2E, a difference from the liquid crystal lens shown in FIG. 2A is that: in the direction from the center toward the circumference of the circle, the thickness of the central portion 621 gradually increases, that is, the portion of the central portion 621 that is closer to the ring portion 622 has a greater thickness; and in the direction from the center toward the circumference of the circle, a thickness of each ring portion 622 also gradually increases. The plurality of sub-electrodes 410 are arranged in different layers; and an insulating layer 700 is provided between two adjacent layers of sub-electrodes 410. In the direction from the center toward the circumference of the circle, distances from a part of sub-electrodes 410 corresponding to the central portion 621 in the plurality of sub-electrodes 410 to the first substrate 100 gradually increase. In the direction from the side closer to the central portion 621 toward the side away from the central portion 621, distances from a part of sub-electrodes 410 corresponding to each ring portion 622 in the plurality of sub-electrodes 410 to the first substrate 100 gradually increase.

For example, in a case of arrangement of the plurality of sub-electrodes shown in FIG. 2E, the plurality of sub-electrodes 410 may be electrically connected, to reduce the number of leads and reduce a process difficulty. The plurality of sub-electrodes 410 may all be applied with a same voltage, and the voltage may be an intermediate state voltage (e.g., 3.5 V) plus 1.5 V to 3.2 V. Of course, the plurality of sub-electrodes may not be limited to being electrically connected to be applied with a same voltage, or the plurality of sub-electrodes may not be electrically connected, but are respectively applied with a same voltage. The embodiment of the present disclosure is not limited thereto, each layer of sub-electrodes may also be applied with a same voltage, but different layers of sub-electrodes are applied with different voltages; and the distances between the sub-electrodes and the second surface of the Fresnel lens are adjusted, to render uniform deflection of liquid crystals located at respective positions on the Fresnel lens.

As compared with the structure shown in FIG. 1A, when the voltage applied to the sub-electrodes 410 according to the embodiment of the present disclosure is slightly greater than the originally applied intermediate state voltage, influence of the Fresnel lens 600 on the electric field may be compensated as far as possible.

In the example, the distances from the sub-electrodes 410 to the interface between the Fresnel lens 600 and the liquid crystal layer 300 are adjusted, so that after the liquid crystals in respective positions are subjected to an electric field and a molecular force between liquid crystals, deflection degrees of the liquid crystals located in positions of different thicknesses on the Fresnel lens 600 are substantially the same, thereby improving the phenomenon of uneven deflection of the liquid crystals. Therefore, in the embodiment of the present disclosure, different intermediate state voltages may be applied to the sub-electrodes to implement continuous change in the refractive index of the liquid crystal layer, so that the liquid crystal lens acts as a continuous zoom lens with high image quality.

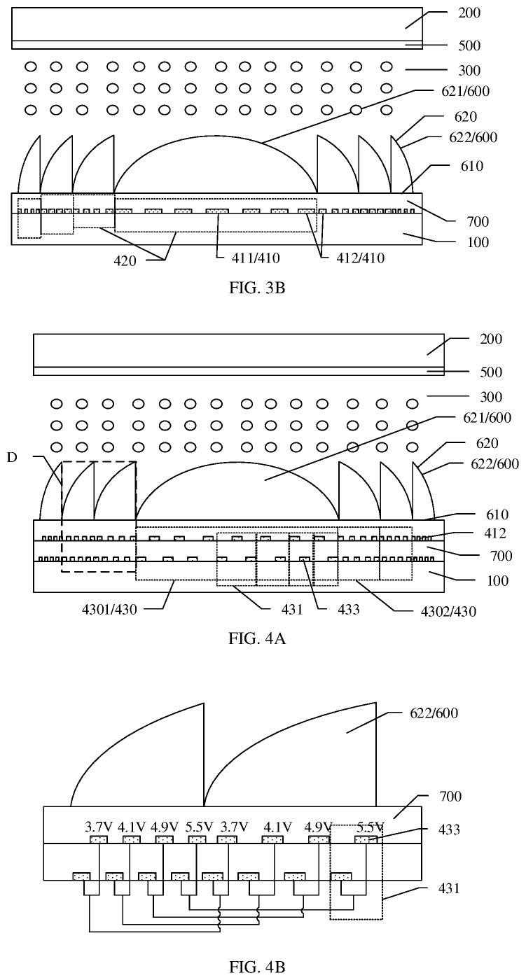

FIG. 3A is a partial cross-sectional schematic diagram of the liquid crystal lens provided by another example of the embodiment of the present disclosure. As shown in FIG. 3A, a difference from the liquid crystal lens shown in FIG. 2A is distribution of the plurality of sub-electrodes. As shown in FIG. 3A, the plurality of sub-electrodes 410 in the example include a plurality of first sub-electrode groups 420 located in a same layer; and each first sub-electrode group 420 includes a first sub-electrode 421 and a second sub-electrode 422 insulated from each other. The first sub-electrode 421 includes a central electrode 411 and a ring electrode 412 located at one end of the ring portion 622 that is close to the central portion 621; and the second sub-electrode 422 includes ring electrodes 412 located on a circumference of a circular orthogonal projection of the central portion 621 on the first substrate 100 and located at one end of the ring portion 622 that is away from the central portion 621. That is, the central portion 621 and each ring portion 622 each correspond to one first sub-electrode group 420; and in each first sub-electrode group 420, the second sub-electrode 422 is further away from the center of the central portion than the first sub-electrode 421. That is, the first sub-electrode 421 is located in a position where the Fresnel lens 600 is relatively thicker, and the second sub-electrode 422 is located in a position where the Fresnel lens 600 is relatively thinner.

For example, as shown in FIG. 3A, in the direction from the center toward the circumference of the circle, in a case where the thickness of the central portion 621 of the Fresnel lens 600 gradually decreases, and a thickness of each ring portion 622 gradually decreases, the first sub-electrode 421 and the second sub-electrode 422 included in each first sub-electrode group 420 are configured to be applied with different voltages, and the voltage applied to the first sub-electrode 421 is greater than the voltage applied to the second sub-electrode 422.

For example, the second sub-electrode 422 is configured to be applied with a voltage the same as the intermediate state voltage applied to the structure shown in FIG. 1A; and a voltage applied to the first sub-electrode 421 is 1.5 V to 3.2 V higher than the voltage applied to the second sub-electrode 422. The voltage applied to the first sub-electrode 421 may be determined according to influence of the thickness of the Fresnel lens 600 on the electric field. At this time, as compared with the structure shown in FIG. 1A, the voltage applied to the second sub-electrode 422 according to the embodiment of the present disclosure is still the original intermediate state voltage, and the voltage applied to first sub-electrode 421 located in a position where the Fresnel lens 600 is thicker is slightly greater than the original intermediate state voltage, which may compensate for influence of the Fresnel lens 600 on the electric field as far as possible.

The example is not limited thereto, for example, in the direction from the center toward the circumference of the circle, in a case where the thickness of the central portion of the Fresnel lens gradually increases, and a thickness of each ring portion gradually increases (the Fresnel lens as shown in FIG. 2E), the first sub-electrode and the second sub-electrode included in each first sub-electrode group are configured to be applied with different voltages, and a voltage applied to the first sub-electrode is less than a voltage applied to the second sub-electrode. The first sub-electrode is configured to be applied with a voltage the same as the intermediate state voltage applied to the structure shown in FIG. 1A, and the voltage applied to the second sub-electrode is 1.5 V to 3.2 V higher than the voltage applied to the first sub-electrode. The voltage applied to the second sub-electrode may be determined according to influence of the thickness of the Fresnel lens on the electric field. At this time, as compared with the structure shown in FIG. 1A, the voltage applied to the first sub-electrode according to the embodiment of the present disclosure is still the original intermediate state voltage, while the voltage applied to the second sub-electrode located in a position where the Fresnel lens is thicker is slightly greater than the original intermediate state voltage, which may compensate for influence of the Fresnel lens on the electric field as far as possible.

For example, in order to implement progressive change in a potential between the first sub-electrode 421 and the second sub-electrode 422 to make the electric field at the interface between the Fresnel lens 600 and the liquid crystal layer 300 substantially uniform, a side of each first sub-electrode group 420 that faces the Fresnel lens 600 may be provided with a high-resistance film 800; and the high-resistance film 800 is made of a transparent material with a relatively great resistance. For example, the material of the high-resistance film 800 may include one or more of silicon oxide, silicon nitride, silicon carbide, aluminum oxide, or a transparent polymer material. For example, a sheet resistance of the high-resistance film 800 is 10³ to 10⁷ Ω/sq. The high-resistance film 800 provided between the first sub-electrode 421 and the second sub-electrode 422 may implement voltage gradient change in a direction from the center toward the circumference of the circle. A planar configuration of the high-resistance film according to the embodiment of the present disclosure is determined according to the shape of the sub-electrode, for example, it is also a circular ring.

For example, the high-resistance film 800 is disconnected at a gap between corresponding two adjacent first sub-electrode groups 420, that is, the high-resistance film 800 includes a plurality of sub-high-resistance films; the plurality of sub-high-resistance films are in one-to-one correspondence with the plurality of first sub-electrode groups 420; and there is a gap between two adjacent sub-high-resistance films.

For example, the high-resistance film 800 is located in a gap between sub-electrodes in each first sub-electrode group 420 (which means that the high-resistance film may fill the gap between the two sub-electrodes in the first sub-electrode group, or may also lap on the two sub-electrodes); and in the direction perpendicular to the first substrate 100, the high-resistance film 800 overlaps only with a portion of the first sub-electrode 421 and a portion of the second sub-electrode 422. That is, the first sub-electrode 421 and the second sub-electrode 422 are respectively located on both sides of the high-resistance film 800, and an orthogonal projection of the high-resistance film 800 on the first substrate 100 covers orthogonal projections of a portion of the first sub-electrode 421 and a portion of the second sub-electrode 422 on the first substrate 100. The embodiment of the present disclosure is not limited thereto, the high-resistance film 800 may also completely cover the first sub-electrode 421 and the second sub-electrode 422, and as long as the high-resistance films 800 corresponding to adjacent first sub-electrode groups 420 are disconnected, progressive change in the potential between the first sub-electrode 421 and the second sub-electrode 422 may be implemented. FIG. 3A schematically shows that the high-resistance film 800 located on the central electrode 411 is disconnected; the example is not limited thereto, and the high-resistance film 800 located on the central electrode 411 may also be continuous.

For example, in the direction from the center toward the circumference of the circle, sizes of the first sub-electrode 421 and the second sub-electrode 422 are 4.0 μm to 6.5 μm.

For example, in the direction from the center toward the circumference of the circle, a size of the portion where the first sub-electrode 421 overlaps with the high-resistance film 800 may be ½ to ⅕ of the size of the first sub-electrode 421, and a size of the portion where the second sub-electrode 422 overlaps with the high-resistance film 800 may be ½ to ⅕ of the size of the second sub-electrode 422, to prevent two adjacent sub-high-resistance films from being in contact with each other.

For example, in the direction from the center toward the circumference of the circle, a size of the high-resistance film 800 may be 0.4 μm less than the size of the ring portion 622.

FIG. 3B is a partial cross-sectional schematic diagram of the liquid crystal lens provided by another example of this embodiment. As shown in FIG. 3B, a difference from the liquid crystal lens shown in FIG. 3A is distribution of the plurality of sub-electrodes. As shown in FIG. 3B, the plurality of sub-electrodes 410 in the example include a plurality of first sub-electrode groups 420 located in a same layer; and each first sub-electrode group 420 includes at least three sub-electrodes 410 insulated from each other. Each ring portion 622 and the central portion 621 are in one-to-one correspondence with the plurality of first sub-electrode groups 420; each first sub-electrode group 420 includes at least two sub-electrodes 410 insulated from each other; and in the direction from the center toward the circumference of the circle, in a case where the thickness of the central portion 621 of the Fresnel lens 600 gradually decreases, and a thickness of each ring portion 622 gradually decreases, the at least three sub-electrodes 410 are configured to be applied with a voltage that gradually decreases. As compared with the example shown in FIG. 3A, in the example, a plurality of sub-electrodes provided between the first sub-electrode and the second sub-electrode are used to replace the high-resistance film, and voltages applied to the plurality of sub-electrodes located between the first sub-electrode and the second sub-electrode change progressively, so that the electric field at the interface between the Fresnel lens and the liquid crystal layer is substantially uniform. The number of the sub-electrodes and sizes thereof in the example may be determined according to the sizes of the central portion and the ring portion that are parallel to the first substrate. The example is not limited thereto, in the direction from the center toward the circumference of the circle, in a case where the thickness of the central portion of the Fresnel lens gradually increases, and a thickness of each ring portion gradually increases (the Fresnel lens as shown in FIG. 2E), the at least three sub-electrodes are configured to be applied with a voltage that gradually increases.

FIG. 4A is a partial cross-sectional schematic diagram of the liquid crystal lens provided by another example of the embodiment of the present disclosure. As shown in FIG. 4A, a difference from the liquid crystal lens shown in FIG. 2A is the distribution of the plurality of sub-electrodes. As shown in FIG. 4A, the plurality of sub-electrodes 410 in the example include a plurality of electrode groups 430 respectively corresponding to the central portion 621 and each ring portion 622, that is, the plurality of sub-electrodes 410 include a first electrode group 4301 corresponding to the central portion 621 and a second electrode group 4302 corresponding to each ring portion 622. Each electrode group 430 includes at least two second sub-electrode groups 431; and each second sub-electrode group 431 includes at least two third sub-electrodes 433 located in different layers. Each second sub-electrode group 431 of FIG. 4A is circled by a dotted frame. In each second sub-electrode group 431, in the direction from the center toward the circumference of the circle, in a case where the thickness of the central portion 621 of the Fresnel lens 600 gradually decreases, and a thickness of each ring portion 622 gradually decreases, distances from the at least two third sub-electrodes 433 to the first substrate 100 gradually decrease, and the at least two third sub-electrodes 433 are configured to be applied with a same voltage.

For example, as shown in FIG. 4A, the numbers of layers of third sub-electrodes 433 in the first electrode group 4301 and the second electrode group 4302 are both P, and in the direction perpendicular to the first substrate 100, a distance from a q-th layer of third sub-electrodes 433 in the second electrode group 4302 to the first substrate 100 is equal to a distance from a q-th layer of third sub-electrodes 433 in the first electrode group 4301 to the first substrate 100, where P≥2 and P≥q≥1. For example, if the third sub-electrodes 433 shown in FIG. 4A are distributed in two layers, that is, each second sub-electrode group 431 includes two third sub-electrodes 433, then the first electrode has a double-layer electrode structure. The example is not limited thereto, and the first electrode may also be three or more layers.

For example, FIG. 4B is an enlarged schematic diagram of a region D in FIG. 4A. As shown in FIG. 4A and FIG. 4B, in the direction from the center toward the circumference of the circle, voltages applied to the second sub-electrode group 431 corresponding to the central portion 621 gradually decrease, and voltages applied to a sub-electrode group 431 corresponding to each ring portion 622 gradually decreases, so that after the liquid crystals in respective positions are subjected to an electric field and a molecular force between liquid crystals, deflection degrees of the liquid crystals on the Fresnel lens 600 of different thicknesses are substantially the same, thereby improving the phenomenon of uneven deflection of the liquid crystals.

The example is not limited thereto, for example, in each second sub-electrode group, in the direction from the center toward the circumference of the circle, in a case where the thickness of the central portion of the Fresnel lens gradually increases, and a thickness of each ring portion gradually increases (the Fresnel lens as shown in FIG. 2E), distances from the at least two third sub-electrodes to the first substrate gradually increase, and the at least two third sub-electrodes are configured to be applied with a same voltage. In the direction from the center toward the circumference of the circle, voltage applied to the second sub-electrode group corresponding to the central portion gradually increase, and voltages applied to the second sub-electrode group corresponding to each ring portion gradually increase, so that after the liquid crystals in respective positions are subjected to an electric field and a molecular force between liquid crystals, deflection degrees of the liquid crystals in positions of different thicknesses on the Fresnel lens 600 are substantially the same, thereby improving the phenomenon of uneven deflection of the liquid crystals.

For example, a third sub-electrode 433 corresponding to a position where the Fresnel lens 600 is thinnest is configured to be applied with a voltage the same as the voltage applied to the intermediate state voltage applied to the structure shown in FIG. 1A; and as the thickness of the Fresnel lens 600 increases, a voltage applied to the third sub-electrode 433 corresponding to the Fresnel lens 600 gradually increases, which may compensate for influence of the Fresnel lens 600 on the electric field as far as possible.

For example, as shown in FIG. 4A, the numbers of the second sub-electrode groups 431 corresponding to the central portion 621 and each ring portion 622 are equal, and FIG. 4A schematically shows that the number of second sub-electrode groups 431 is 4, but is not limited thereto, and may be determined according to the size of the ring portion 622 and a size of the third sub-electrode 433, as long as the deflection degrees of the liquid crystals on the Fresnel lens 600 of different thicknesses are substantially the same, thereby improving the phenomenon of uneven deflection of the liquid crystals.

For example, as shown in FIG. 4A and FIG. 4B, the second sub-electrode groups 431 corresponding to the central portion 621 are electrically connected with second sub-electrode groups 431 corresponding to at least one ring portion 622 in one-to-one correspondence; and the second sub-electrode groups 431 corresponding to two adjacent ring portions 622 are electrically connected in one-to-one correspondence. That is, the second sub-electrode groups 431 corresponding to the central portion 621 and the ring portion 622 are applied with voltages on a same rule, so that the deflection degrees of the liquid crystals on the Fresnel lens 600 of different thicknesses are substantially the same, thereby improving the phenomenon of uneven deflection of the liquid crystals. The example may also simplify a process and control the number of leads.

FIG. 5 is a partial cross-sectional schematic diagram of a liquid crystal lens provided by another embodiment of the present disclosure. As shown in FIG. 5, this embodiment differs from the embodiment shown in FIG. 2A in position and structure of the first electrode 400, wherein, the first electrode 400 is a continuous electrode located on the second surface 620 of the Fresnel lens 600. A shape of the Fresnel lens in the example may be the shape shown in FIG. 2A or the shape shown in FIG. 2E, which will not be limited here.

For example, the first electrode 400 is conformally formed on the second surface 620 of the Fresnel lens 600, that is, the first electrode 400 as formed is a whole-layer transparent electrode deposited on the second surface 620 of the Fresnel lens 600; thicknesses in different positions of the first electrode 400 are substantially the same; then the surface configuration of a side of the first electrode 400 that is away from the Fresnel lens 600 is the same as the second surface configuration of the Fresnel lens 600.

For example, a thickness of the first electrode 400 in the direction perpendicular to the first substrate 100 may be 0.04 μm to 0.07 μm, which, thus, may not only ensure that the first electrode 400 will not be broken at a groove on the second surface of the Fresnel lens 600 due to a relatively thin thickness, but also ensure that the first electrode 400 is not too thick to affect the electric field.

The first electrode according to this embodiment is provided on the side of the Fresnel lens that faces the liquid crystal layer, which may prevent the Fresnel lens from affecting the electric field; when the first electrode is applied with a voltage the same as the intermediate state voltage applied to the structure shown in FIG. 1A, after the liquid crystals in respective positions of the Fresnel lens are subjected by a combined action of the electric field and the intermolecular force, deflection degrees of the liquid crystals in positions of different thicknesses on the Fresnel lens 600 may be substantially the same, thereby improving the phenomenon of uneven deflection of the liquid crystals. Therefore, in the embodiment of the present disclosure, different intermediate state voltages may be applied to the first electrode to implement continuous change in the refractive index of the liquid crystal layer, so that the liquid crystal lens acts as a continuous zoom lens with high image quality.

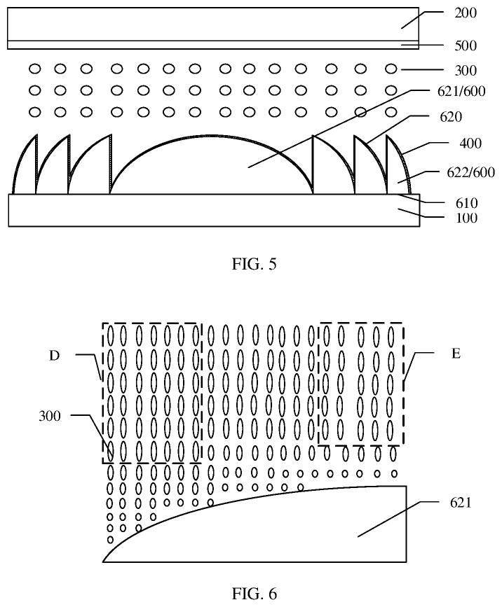

FIG. 6 is a schematic diagram of deflection states of liquid crystals in a region located above the central portion of the Fresnel lens when the intermediate state voltage is applied to the first electrode according to the respective embodiments shown in FIG. 2A to FIG. 2D and FIG. 3A to FIG. 5. As shown in FIG. 6, taking the liquid crystals located at the central portion of the Fresnel lens as an example, liquid crystals located within a region D above a thinner position (a low arch region) at the central portion and located within a region E above a thicker position (a high arch region) at the central portion are substantially in a normally deflected state (vertical to the first transparent substrate). At this time, refractive indices of respective positions of the liquid crystal layer are substantially uniform, and blurred imaging caused by stray light will not appear. Therefore, the liquid crystals in the liquid crystal glasses shown in FIG. 2A to FIG. 5 may implement continuous change in the refractive index, so as to implement adjustable degrees of the glasses. Of course, liquid crystal deflection at respective positions in the example shown in FIG. 2E is also uniform.

Another embodiment of the present disclosure provides liquid crystal glasses, comprising the liquid crystal lens provided by any one of the above-described embodiments; the liquid crystals in the liquid crystal glasses provided by the embodiment of the present disclosure are uniformly deflected under an action of an electric field generated by applying an intermediate state voltage, which may implement continuous change in a refractive index, thereby implementing adjustable degrees of the glasses. In addition, the liquid crystal glasses provided by the embodiment of the present disclosure may further implement multi-functional transformations such as concave lenses and convex lenses, to meet needs of various users.

The following points should be noted:

(1) Only the structures relevant to the embodiments of the present invention are involved in the accompanying drawings of the embodiments of the present invention, and other structures may refer to the prior art.

(2) The embodiments of the present invention and the characteristics in the embodiments may be mutually combined without conflict.

The foregoing is merely exemplary embodiments of the invention, but is not used to limit the protection scope of the invention. The protection scope of the invention shall be defined by the attached claims.

1. A liquid crystal lens, comprising:
a first substrate, a second substrate opposite to the first substrate, and a liquid crystal layer between the first substrate and the second substrate;
a first electrode on a side of the first substrate that faces the second substrate, and a second electrode on a side of the second substrate that faces the first substrate; and
a Fresnel lens between the first substrate and the liquid crystal layer, the Fresnel lens including a flat first surface and a second surface provided with a teeth profile that are arranged opposite to each other, and the liquid crystal layer being on a side of the second surface that is away from the first surface,
wherein the first electrode is on a side of the Fresnel lens that faces the first substrate, and the first electrode includes a plurality of sub-electrodes separated from each other.

2. The liquid crystal lens according to claim 1, wherein the Fresnel lens includes a central portion and a plurality of ring portions surrounding the central portion; an orthogonal projection of the central portion on the first substrate is a circle; in a direction from a center toward a circumference of the circle, a thicknesses of the central portion and a thickness of each of the plurality of ring portions gradually change, and both have a same trend of change in thickness,
the plurality of sub-electrodes include a central electrode and a ring electrode surrounding the central electrode; and the center of the circle is located within an orthogonal projection of the central electrode on the first substrate.

3. The liquid crystal lens according to claim 2, wherein the plurality of sub-electrodes are arranged in different layers; an insulating layer is provided between two adjacent layers of sub-electrodes; in the direction from the center toward the circumference of the circle, the thickness of the central portion and the thickness of each of the plurality of ring portions both gradually decrease; distances from a first part of sub-electrodes corresponding to the central portion in the plurality of sub-electrodes to the first substrate gradually decrease; and distances from a second part of sub-electrodes corresponding to each of the ring portions in the plurality of sub-electrodes to the first substrate gradually decrease.

4. The liquid crystal lens according to claim 2, wherein the plurality of sub-electrodes are arranged in different layers; an insulating layer is provided between two adjacent layers of sub-electrodes; in the direction from the center toward the circumference of the circle, the thickness of the central portion and the thickness of each of the plurality of ring portions both gradually increase; distances from a first part of sub-electrodes corresponding to the central portion in the plurality of sub-electrodes to the first substrate gradually increase; and distances from a second part of sub-electrodes corresponding to each of the ring portions in the plurality of sub-electrodes to the first substrate gradually increase.

5. The liquid crystal lens according to claim 3, wherein the plurality of sub-electrodes are configured to be applied with a same voltage.

6. The liquid crystal lens according to claim 5, wherein a dielectric constant of the insulating layer is substantially the same as a dielectric constant of the Fresnel lens.

7. The liquid crystal lens according to claim 5, wherein a number of layers of the first part of sub-electrodes and a number of layers of the second part of sub-electrodes are both N; and in a direction perpendicular to the first substrate, a distance from an m-th layer of the first part of sub-electrodes to the first substrate is equal to a distance from an m-th layer of the second part of sub-electrodes to the first substrate, where N≥3 and N≥m≥1.

8. The liquid crystal lens according to claim 2, wherein the plurality of sub-electrodes include a plurality of first sub-electrode groups located in a same layer; the plurality of ring portions and the central portion are in one-to-one correspondence with the plurality of first sub-electrode groups; and each of the plurality of first sub-electrode groups includes at least two sub-electrodes insulated from each other;
in the direction from the center toward the circumference of the circle, the thickness of the central portion and the thickness of each of the plurality of ring portions both gradually decrease;
and the at least two sub-electrodes are configured to be applied with voltages that gradually decrease; or
in the direction from the center toward the circumference of the circle, the thickness of the central portion and the thickness of each of the plurality of ring portions both gradually increase; and the at least two sub-electrodes are configured to be applied with voltages that gradually increase.

9. The liquid crystal lens according to claim 8, wherein each of the plurality of first sub-electrode groups includes two sub-electrodes; a side of each of the plurality of first sub-electrode groups that faces the Fresnel lens is provided with a high-resistance film; and the high-resistance film is disconnected at a gap between two adjacent first sub-electrode groups in the plurality of first sub-electrode groups.

10. The liquid crystal lens according to claim 9, wherein, in the direction from the center toward the circumference of the circle, a size of a portion where each sub-electrode overlaps with the high-resistance film is ½ to ⅕ of a size of the sub-electrode.

11. The liquid crystal lens according to claim 9, wherein, in the direction from the center toward the circumference of the circle, a size of each of the sub-electrodes is 4.0 μm to 6.5 μm.

12. The liquid crystal lens according to claim 2, wherein the plurality of sub-electrodes include a first electrode group corresponding to the central portion and a second electrode group corresponding to each of the plurality of ring portions; the first electrode group and the second electrode group each include at least two second sub-electrode groups; and each of the at least two second sub-electrode groups includes at least two third sub-electrodes located in different layers;
in the direction from the center toward the circumference of the circle, the thickness of the central portion and the thickness of each of the plurality of ring portions both gradually decrease; in each of the second sub-electrode groups, distances from the at least two third sub-electrodes to the first substrate gradually decrease; and the at least two third sub-electrodes are configured to be applied with a same voltage; or
in the direction from the center toward the circumference of the circle, the thickness of the central portion and the thickness of each of the plurality of ring portions both gradually increase; in each of the second sub-electrode groups, distances from the at least two third sub-electrodes to the first substrate gradually increase; and the at least two third sub-electrodes are configured to be applied with a same voltage.

13. The liquid crystal lens according to claim 12, wherein numbers of layers of third sub-electrodes in the first electrode group and the second electrode group are both P; and in a direction perpendicular to the first substrate, a distance from a q-th layer of third sub-electrodes in the second electrode group to the first substrate is equal to a distance from a q-th layer of third sub-electrodes in the first electrode group to the first substrate, where P≥2 and P≥q≥1;
in the direction from the center toward the circumference of the circle, the thickness of the central portion and the thickness of each of the plurality of ring portions both gradually decrease; the at least two second sub-electrode groups corresponding to the central portion are configured to be applied with voltages that gradually decrease; and the at least two second sub-electrode groups corresponding to each of the plurality of ring portions are configured to be applied with voltages that gradually decrease; or
in the direction from the center toward the circumference of the circle, the thickness of the central portion and the thickness of each of the plurality of ring portions both gradually increase; the at least two second sub-electrode groups corresponding to the central portion are configured to be applied with voltages that gradually increase; and the at least two second sub-electrode groups corresponding to each of the plurality of ring portions are configured to be applied with voltages that gradually increase.

14. The liquid crystal lens according to claim 13, wherein the first electrode group and the second electrode group include the same number of second sub-electrode groups; the at least two second sub-electrode groups corresponding to the central portion are electrically connected with the at least two second sub-electrode groups corresponding to the plurality of ring portions in one-to-one correspondence; and the at least two second sub-electrode groups corresponding to two adjacent ring portions in the plurality of ring portions are electrically connected in one-to-one correspondence.

15. The liquid crystal lens according to claim 1, wherein a refractive index of a liquid crystal in the liquid crystal layer is configured to change between a first refractive index n1 and a second refractive index n2; and a refractive index n0 of the Fresnel lens satisfies: n1≥n0≥n2.

16. A liquid crystal lens, comprising:
a first substrate, a second substrate opposite to the first substrate, and a liquid crystal layer between the first substrate and the second substrate;
a first electrode on a side of the first substrate that faces the second substrate, and a second electrode on a side of the second substrate that faces the first substrate; and
a Fresnel lens between the first substrate and the liquid crystal layer; the Fresnel lens including a flat first surface and a second surface provided with a teeth profile that are arranged opposite to each other; and the liquid crystal layer being on a side of the second surface that is away from the first surface,
wherein the first electrode is a continuous electrode on the second surface of the Fresnel lens.

17. The liquid crystal lens according to claim 16, wherein the first electrode is conformally formed on the second surface of the Fresnel lens.

18. The liquid crystal lens according to claim 16, wherein a thickness of the first electrode in a direction perpendicular to the first substrate is 0.04 μm to 0.07 μm.

19. A liquid crystal glasses, comprising a liquid crystal lens which comprises:
a first substrate, a second substrate opposite to the first substrate, and a liquid crystal layer between the first substrate and the second substrate;
a first electrode on a side of the first substrate that faces the second substrate, and a second electrode on a side of the second substrate that faces the first substrate: and
a Fresnel lens between the first substrate and the liquid crystal layer, the Fresnel lens including a flat first surface and a second surface provided with a teeth profile that are arranged opposite to each other, and the liquid crystal layer being on a side of the second surface that is away from the first surface,
wherein the first electrode is on a side of the Fresnel lens that faces the first substrate, and the first electrode includes a plurality of sub-electrodes separated from each other.
